(19) United States
(12) Patent Application Publication
(10) Pub. No.: US 2019/0078522 A1
(43) Pub. Date: Mar. 14, 2019

(54) DEDICATED EXHAUST GAS RECIRCULATING (EGR) SYSTEM

(71) Applicant: Cummins Inc., Columbus, IN (US)

(72) Inventors: Shashank Tamaskar, Columbus, IN (US); Anthony Kyle Perfetto, Columbus, IN (US); David J. Stroh, Columbus, IN (US)

(73) Assignee: Cummins Inc., Columbus, IN (US)

(21) Appl. No.: 15/701,807

(22) Filed: Sep. 12, 2017

(51) Int. Cl. F02D 41/00

(52) U.S. Cl. CPC F02D 41/0065; F02M 26/43

(57) ABSTRACT

Systems and apparatuses include an engine having a cylinder and a dedicated cylinder, an air intake system providing fresh air to the engine, a fueling system providing fuel to the cylinder and the dedicated cylinder, an exhaust gas recirculation pathway from the dedicated cylinder to the air intake system, and a controller structured to control the fueling system and the air intake system to provide a lean air-to-fuel mixture to the dedicated cylinder during a low-load condition, and to provide a rich air-to-fuel mixture to the dedicated cylinder after a tip-in event.

### TECHNICAL FIELD

This disclosure relates generally to fueling control, and more particularly to dedicated exhaust gas recirculation (EGR) fueling control.

### BACKGROUND

EGR is used to reduce the amount of nitrous oxides in exhaust gas generated by an internal combustion engine and can be used to reduce the occurrence of knocking combustion. EGR systems re-circulate a portion of the exhaust gas generated by a combustion event within a combustion chamber of the engine back into the combustion chamber for a future combustion event. The recirculated exhaust gas reduces the temperature of the combustion components prior to combustion. The lower temperature of the combustion components promotes a reduction in the amount of nitrous oxides generated as a result of the combustion process and may reduce engine knock.

In a dedicated exhaust gas recirculation (D-EGR), one or more dedicated donor cylinders may provide the exhaust gas that is re-circulated. The dedicated cylinder is typically provided with a rich air-to-fuel ratio (lambda λ<1) to produce an excess of hydrogen. The hydrogen rich exhaust from the dedicated cylinder is then remixed with air and delivered to the intake of the internal combustion engine. The hydrogen-rich air improves emission levels and improves knock-resistance.

### SUMMARY

One embodiment relates to an apparatus that includes a control circuit structured to receive signals from an engine sensor indicating an engine characteristic, determine a low-load condition if the engine characteristic is less than or equal to a predetermined threshold, control a fueling system so that a lean air-to-fuel mixture is delivered to a dedicated cylinder during the low-load condition, determine a tip-in event has occurred subsequent to controlling the fueling system, and control the fueling system so that a rich air-to-fuel mixture is delivered to the dedicated cylinder after the tip-in event.

Another embodiment relates to a system that includes an engine having a cylinder and a dedicated cylinder, an air intake system providing fresh air to the engine, a fueling system providing fuel to the cylinder and the dedicated cylinder, an exhaust gas recirculation pathway from the dedicated cylinder to the air intake system, and a controller structured to control the fueling system and the air intake system to provide a lean air-to-fuel mixture to the dedicated cylinder during a low-load condition, and to provide a rich air-to-fuel mixture to the dedicated cylinder after a tip-in event.

Another embodiment relates to a method that includes receiving signals from an engine sensor indicating an engine characteristic, determining a low-load condition if the engine characteristic is less than or equal to a predetermined threshold, controlling a fueling system so that a lean air-to-fuel mixture is delivered to a dedicated cylinder during the low-load condition, determining a tip-in event has occurred subsequent to controlling the fueling system, and controlling the fueling system so that a rich air-to-fuel mixture is delivered to the dedicated cylinder after the tip-in event.

These and other features, together with the organization and manner of operation thereof, will become apparent from the following detailed description when taken in conjunction with the accompanying drawings.

### BRIEF DESCRIPTION OF THE FIGURES

FIG. 1 is a schematic representation of an engine system according to an example embodiment.

FIG. 2 is a schematic representation of a controller of the engine system of FIG. 1 according to an example embodiment.

FIG. 3 is flow chart representing a method of operating the engine system of FIG. 1 according to an example embodiment.

FIG. 4 is a graph showing torque output over time of the engine system according to an example embodiment.

### DETAILED DESCRIPTION

Following below are more detailed descriptions of various concepts related to, and implementations of, methods, apparatuses, and systems for a dedicated exhaust gas recirculation (D-EGR) fueling control system. The various concepts introduced above and discussed in greater detail below may be implemented in any number of ways, as the concepts described are not limited to any particular manner of implementation. Examples of specific implementations and applications are provided primarily for illustrative purposes.

Referring to the figures generally, the various embodiments disclosed herein relate to systems, apparatuses, and methods for a D-EGR fueling control system for an internal combustion engine that provides a lean air-to-fuel ratio (e.g., an air-to-fuel equivalence ratio lambda λ>1) in a low engine load condition. When experiencing a low load, the engine has a higher inherent knock tolerance. The D-EGR fueling control system takes advantage of the knock tolerance at low load and provides a dedicated cylinder with a lean air-to-fuel ratio to provide an increased torque condition during a tip-in event (i.e., an increase in engine load). When the D-EGR fueling control system determines a tip-in event is occurring (e.g., a user has pressed down on the accelerator petal), a rich air-to-fuel ratio (e.g., an air-to-fuel equivalence ratio lambda λ<1) is provided to the dedicated cylinder so that all engine cylinders are producing a desired torque and the dedicated cylinder is producing EGR at a desired load. By providing a lean air-to-fuel ratio at low engine load (e.g., at idle), the engine is provided with extra torque for several engine cycles at tip-in thereby improving engine and vehicle response at tip-in.

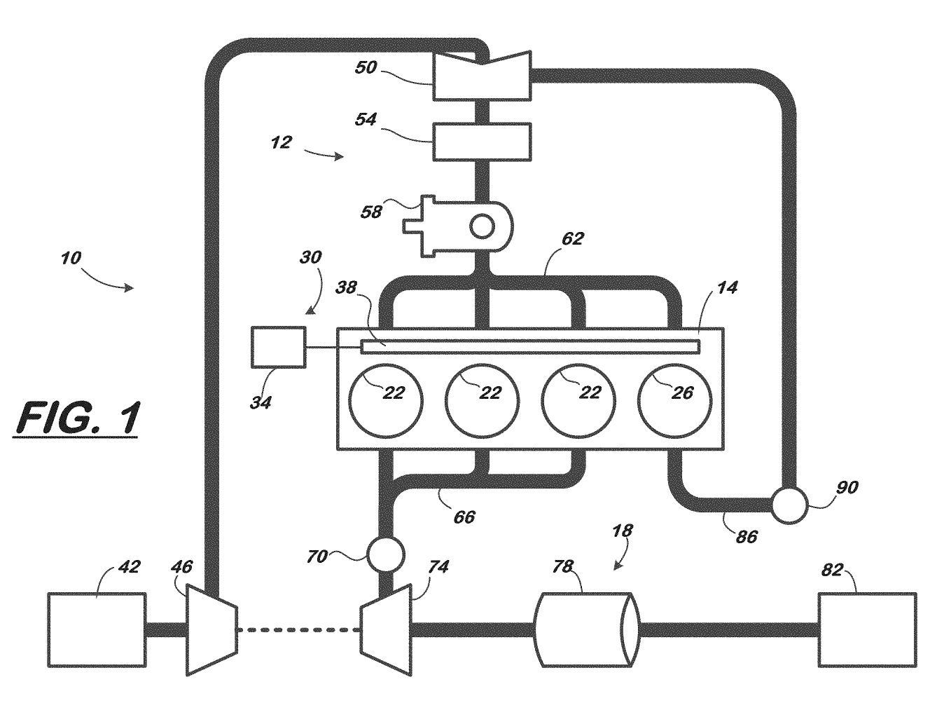

As shown in FIG. 1, an engine system 10 includes an air intake system 12 that provides intake air, an engine 14 that receives the intake air, and an exhaust aftertreatment system 18 that receives and treats exhaust gases produced by the engine 14. The engine 14 can be a compression-ignited internal combustion engine, such as a diesel-fueled engine, or a spark-ignited internal combustion engine, such as a gasoline-fueled engine. The engine 14 includes three cylinders 22 and a dedicated cylinder 26, but could be configured in multiple ways with two or more cylinders and one or more dedicated cylinders.

A fueling control system 30 includes a fuel controller 34 arranged to control an amount of fuel delivered from a fuel rail 38 to each of the cylinders 22 and the dedicated cylinder 26. In some embodiments, the fuel controller 34 operates in response to a throttle or an accelerator pedal. In some embodiments, the engine 14 includes more than four total cylinders or less than four total cylinders, and/or includes more than one dedicated cylinder. In some embodiments, the fuel controller 34 includes a fuel pump or other fuel delivery components, as desired. Fuel from a fuel tank (not shown) is injected into the combustion chambers of cylinders 22 and the dedicated cylinder 26 by the fueling control system 30. Fuel injection timing can be controlled by the fuel controller 34 via a fuel injector control signal.

The air intake system 12 includes an air inlet 42, a compressor 46 that receives fresh air from the air inlet 42, a mixer 50 that receives pressurized air from the compressor 46, a heat exchanger or intercooler 54 that receives and cools mixed air, and a main throttle valve 58 that alters the amount of cooled and mixed air that is provided to an intake manifold 62. The intake manifold 62 provides mixed intake air to the cylinders 22 and the dedicated cylinder 26. The air intake system 12 coordinates with the fueling control system 30 to provide a desired air-to-fuel ratio to each of the cylinders 22 and the dedicated cylinder 26. In some embodiments, the fueling control system 30 controls or directs operation of the air intake system 12. In some embodiments, the intake ports are of a high tumble charge motion design to improve the combustion stability of the dedicated EGR cylinder when operated in a lean state with EGR.

The exhaust aftertreatment system 18 includes an exhaust manifold 66 that receives exhaust gases from the cylinders 22, an exhaust gas sensor in the form of a heated exhaust gas oxygen (HEGO) sensor 70 positioned to measure excess exhaust oxygen concentration, a waste gate turbine 74 that receives exhaust gases from the exhaust manifold 66, a catalyst in the form of a three-way catalyst 78 that receives exhaust gases from the waste gate turbine 74, and a muffler 82 or other downstream exhaust handling device or system. In other embodiments, the exhaust aftertreatment system may include a selective catalyst reduction (SCR) system or another aftertreatment system as desired.

An EGR return pathway 86 provides exhaust gases from the dedicated cylinder 26 to the mixer 50 so that dedicated exhaust gases may be mixed with fresh air within the mixer 50. A sensor in the form of an universal exhaust gas oxygen (UEGO) sensor 90 is positioned in the EGR return pathway 86 and measures a proportion of oxygen in the exhaust gas from the dedicated cylinder 26.

Generally, within the engine 14, air from the atmosphere is combined with fuel, and combusted, to power the engine. Combustion of the fuel and air in the compression chambers of the engine 14 produces exhaust gas that is operatively vented to the exhaust manifold 66. From the exhaust manifold 66, a portion of the exhaust gas may be used to power the waste gate turbine 74 (e.g., a turbocharger turbine). The waste gate turbine 74 drives the compressor 46, which may compress at least some of the air entering the air inlet 42 before directing it to the mixer 50 and into the compression chambers of the engine 14.

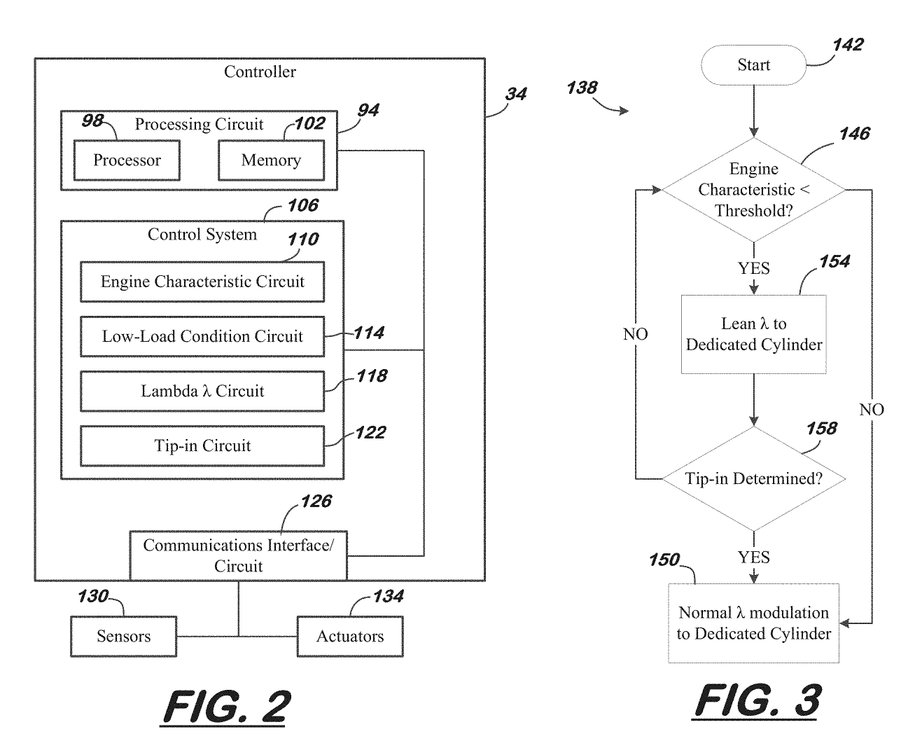

As the components of FIG. 1 are shown to be embodied in the engine system 10 that may be associated with a vehicle, the fuel controller 34 may be structured as one or more electronic control units (ECU). The fuel controller 34 may be separate from or included with at least one of a transmission control unit, an exhaust aftertreatment control unit, a powertrain control module, an engine control module, etc. The function and structure of the fuel controller 34 is described in greater detail in FIG. 2.

Referring now to FIG. 2, a schematic diagram of the fuel controller 34 of the engine system 10 of FIG. 1 is shown according to an example embodiment. As shown in FIG. 2, the fuel controller 34 includes a processing circuit 94 having a processor 98 and a memory device 102, a control system 106 having an engine characteristic circuit 110, a low-load condition circuit 114, a lambda λ circuit 118, and a tip-in circuit 122, and a communications interface 126. Generally, the fuel controller 34 is structured to monitor an engine characteristic (e.g., torque loading, torque reserve, engine speed, etc.), determine if a low-load condition exists, operate the dedicated cylinder 26 lean during a low-load condition, and operate the dedicated cylinder 26 rich after a tip-in is determined.

In one configuration, the engine characteristic circuit 110, the low-load condition circuit 114, the lambda λ circuit 118, and the tip-in circuit 122 are embodied as machine or computer-readable media that is executable by a processor, such as processor 98. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the engine characteristic circuit 110, the low-load condition circuit 114, the lambda λ circuit 118, and the tip-in circuit 122 are embodied as hardware units, such as electronic control units. As such, the engine characteristic circuit 110, the low-load condition circuit 114, the lambda λ circuit 118, and the tip-in circuit 122 may be embodied as one or more circuitry components including, but not limited to, processing circuitry, network interfaces, peripheral devices, input devices, output devices, sensors, etc. In some embodiments, the engine characteristic circuit 110, the low-load condition circuit 114, the lambda λ circuit 118, and the tip-in circuit 122 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the engine characteristic circuit 110, the low-load condition circuit 114, the lambda λ circuit 118, and the tip-in circuit 122 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The engine characteristic circuit 110, the low-load condition circuit 114, the lambda λ circuit 118, and the tip-in circuit 122 may also include programmable hardware devices such as field programmable gate arrays, programmable array logic, programmable logic devices or the like. The engine characteristic circuit 110, the low-load condition circuit 114, the lambda λ circuit 118, and the tip-in circuit 122 may include one or more memory devices for storing instructions that are executable by the processor(s) of the engine characteristic circuit 110, the low-load condition circuit 114, the lambda λ circuit 118, and the tip-in circuit 122. The one or more memory devices and processor(s) may have the same definition as provided below with respect to the memory device 102 and processor 98. In some hardware unit configurations, the engine characteristic circuit 110, the low-load condition circuit 114, the lambda λ circuit 118, and the tip-in circuit 122 may be geographically dispersed throughout separate locations in the vehicle. Alternatively and as shown, the engine characteristic circuit 110, the low-load condition circuit 114, the lambda λ circuit 118, and the tip-in circuit 122 may be embodied in or within a single unit/housing, which is shown as the fuel controller 34.

In the example shown, the fuel controller 34 includes a processing circuit 94 having a processor 98 and a memory 102. The processing circuit 94 may be structured or configured to execute or implement the instructions, commands, and/or control processes described herein with respect to the engine characteristic circuit 110, the low-load condition circuit 114, the lambda λ circuit 118, and the tip-in circuit 122. The depicted configuration represents the engine characteristic circuit 110, the low-load condition circuit 114, the lambda λ circuit 118, and the tip-in circuit 122 as machine or computer-readable media. However, as mentioned above, this illustration is not meant to be limiting as the present disclosure contemplates other embodiments where the engine characteristic circuit 110, the low-load condition circuit 114, the lambda λ circuit 118, and the tip-in circuit 122, or at least one circuit of the engine characteristic circuit 110, the low-load condition circuit 114, the lambda λ circuit 118, and the tip-in circuit 122, is configured as a hardware unit. All such combinations and variations are intended to fall within the scope of the present disclosure.

The processor 98 may be implemented as one or more general-purpose processor, an application specific integrated circuit (ASIC), one or more field programmable gate arrays (FPGAs), a digital signal processor (DSP), a group of processing components, or other suitable electronic processing components. In some embodiments, the one or more processors may be shared by multiple circuits (e.g., the engine characteristic circuit 110, the low-load condition circuit 114, the lambda λ circuit 118, and the tip-in circuit 122 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure. The memory 102 (e.g., RAM, ROM, Flash Memory, hard disk storage, etc.) may store data and/or computer code for facilitating the various processes described herein. The memory 102 may be communicably connected to the processor 98 to provide computer code or instructions to the processor 98 for executing at least some of the processes described herein. Moreover, the memory 102 may be or include tangible, non-transient volatile memory or non-volatile memory. Accordingly, the memory 102 may include database components, object code components, script components, or any other type of information structure for supporting the various activities and information structures described herein.

The engine characteristic circuit 110 is structured to receive information from sensors 130 (e.g., the HEGO sensor 70, the UEGO sensor 90, engine speed tachometer, torque sensors, etc.) and determine an engine characteristic. The determination of the engine characteristic may include calculation or transformation of signals and/or data received from the sensors 130. In some embodiments, the engine characteristic is engine torque, engine speed, or torque reserve (i.e., an amount of torque that the engine has available to power accessories such as an air conditioner and alternator in addition to moving the vehicle). In other embodiments, another engine characteristic that is indicative of a low load condition may be used.

The low-load condition circuit 114 is structured to compare the determined engine characteristic to a predetermined threshold. If the determined engine characteristic is below the predefined threshold, then the low-load condition circuit 114 indicates that the engine 14 is operating in a low-load condition.

The lambda λ circuit 118 is structured to control actuators 134 (e.g., a fuel pump, the fuel rail 38, the throttle 58, other air intake system 12 components, etc.) based at least in part on information received from the engine characteristic circuit 110, the low-load circuit 114, and/or the tip-in circuit 122 to control an air-to-fuel ratio delivered to each of the cylinders 22 and the dedicated cylinder 26.

The tip-in circuit 122 is structured to receive information from the sensors 130 (e.g., an accelerator pedal sensor, a throttle sensor, etc.) and determines if the engine 14 is experiencing a tip-in event where the engine 14 or the user desires more power, torque, or speed. Generally, a tip-in event is determined anytime the engine 14 moves from a low-load condition to a higher load condition (e.g., a low speed to a higher speed, a low torque to a higher torque, etc.).

As shown in FIG. 3, a method 138 of operating the engine system 10 includes starting the engine 14 at step 142. During operation of the engine 14, the fuel controller 34 monitors the engine characteristic with the engine characteristic circuit 110 and compares the engine characteristic to a predetermined threshold at step 146. In some embodiments, the low-load condition circuit 114 determines if the engine 14 is in an idle state that corresponds to a low-load state. If the engine characteristic is not below a threshold (e.g., engine speed or loading are above idle), then the lambda λ circuit 118 controls the air-to-fuel ratios of the cylinders 22 and the dedicated cylinder 26 normally at step 150. In some embodiments, the cylinders 22 are operated at near stoichiometric (e.g., λ=1) and the dedicated cylinder 26 is operated rich (e.g., 0.7<λ<0.8). Rich operation of the dedicated cylinder 26 produces some hydrogen and carbon monoxide which help stabilize the combustion process in the engine 14 in addition to improving knock tolerance.

If the low-load condition circuit 114 determines that the engine characteristic is less than the threshold at step 146, a low-load condition is determined (e.g., the engine 14 is idling) and the method 138 progresses to step 154. While the engine 14 is operating in the low-load condition, the lambda λ circuit 118 operates the dedicated cylinder lean (e.g., λ>1). In some embodiments, the dedicated cylinder 26 is operated at a lambda λ of up to about 1.50. Operating the dedicated cylinder 26 lean during a low-load condition lowers the effective EGR fraction mixed with the fresh air in the mixer 50. The lower effective EGR fraction allows more fuel to be added to the cylinders 22 and dedicated cylinder 26 when increased speed or torque is required. In turn, the response time of the engine 14 is improved.

At step 158, the fuel controller 34 monitors for a tip-in event using the tip-in circuit 122. If no tip-in event is determined, then the method 138 continues by determining if the engine 14 is operating in a low-load condition at step 146 and operating the dedicated cylinder 26 lean at step 154. If the tip-in circuit determines at step 158 that a tip-in event has occurred, then the lambda λ circuit 118 operates the dedicated cylinder 26 rich (e.g., λ=0.8). When the tip-in event is determined, the fuel controller 34 actuates the fueling control system 30 so that a rich air-to-fuel ratio is provided to the dedicated cylinder 26, but the lean air-to-fuel mixture is still provided to the dedicated cylinder for a delay time determined by the volume of the EGR return pathway 86 and a volume of the dedicated cylinder 26. In some embodiments, the number of engine cycles for which the dedicated cylinder will receive a lean air-to-fuel ratio is determined as a function of the volume of the EGR return pathway 86 and the volume of the dedicated cylinder 26 (e.g., N=Volume_{EGR}_{_}ᵣₑₜᵤᵣₙ_{_}_{pathway}/Volume_{dedicated}_{_}_{cylinder}).

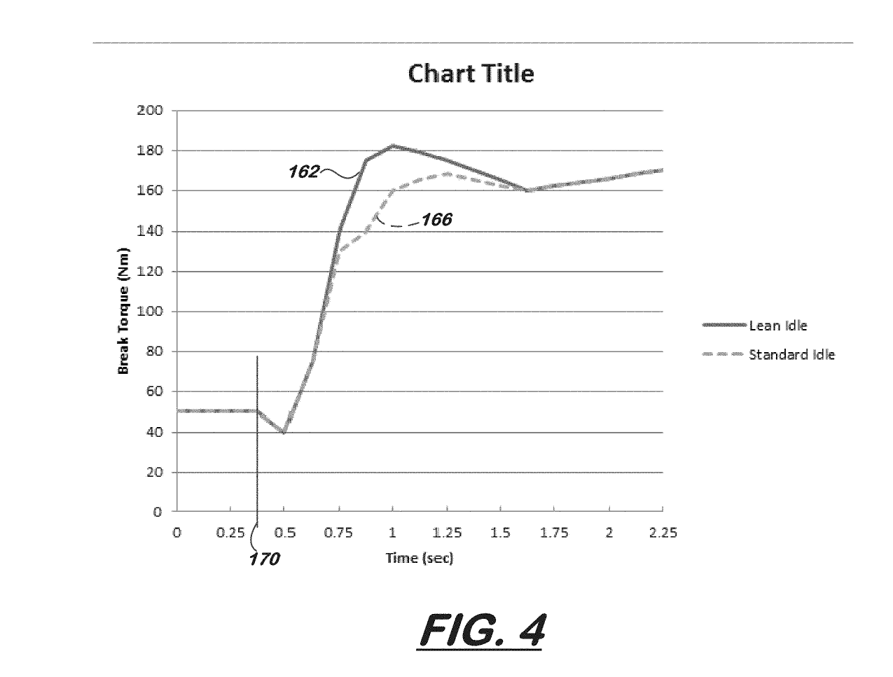

As shown in FIG. 4, in one embodiment, a lean idle 162 is provided to the dedicated cylinder 26 with a lambda λ equal to about 1.5 and provides about twenty-five percent extra torque production during a tip-in event when compared to a standard idle 166 with a lambda λ of about 0.8 in the dedicated cylinder 26. In the example shown in FIG. 4, the lean idle is provided until a tip in event 170 is determined at about 0.375 seconds. After the tip-in event 170, a rich air-to-fuel ratio (e.g., lambda λ=0.8) is provided to the dedicated cylinder 26. As shown by the difference between the lean idle line 162 and the standard idle line 166, the latent oxygen available over the number of engine cycles results in a relative increase in torque production. The increase torque results in a better response to accelerator pedal input or other user/engine input that requires an increased engine load.

Changing the lambda λ provided to the dedicated cylinder 26 in this fashion can impact engine subsystems due to changes in EGR flow and quality. For example, the air estimation will change due to changes in the effective EGR fraction, the fuel estimation will change due to unburnt fuel change, and the spark timing will change due to changes in the effective EGR fraction and quality. These changes can be mitigated by incorporating transient corrections to account for delays in EGR or changing EGR quality. These corrections can be table based or model based.

In some embodiments, the dedicated cylinder 26 can be operated with a fuel cut during idle. However, a fuel cut dedicated cylinder idle can lead to unfavorable vibrations. In some embodiments, an air-to-fuel ratio coefficient λ of about 1.5 is the maximum desirable. In some embodiments, an air-to-fuel ratio coefficient λ of between about 1.5 and about 1.15 is desirable. In some embodiments, the EGR return pathway 86 does not include an EGR valve so that the effective EGR fraction is controlled substantially only by the air-to-fuel mixture provided to the dedicated cylinder.

No claim element herein is to be construed under the provisions of 35 U.S.C. § 112(f), unless the element is expressly recited using the phrase “means for.”

For the purpose of this disclosure, the term “coupled” means the joining or linking of two members directly or indirectly to one another. Such joining may be stationary or moveable in nature. For example, a propeller shaft of an engine “coupled” to a transmission represents a moveable coupling. Such joining may be achieved with the two members or the two members and any additional intermediate members. For example, circuit A communicably “coupled” to circuit B may signify that the circuit A communicates directly with circuit B (i.e., no intermediary) or communicates indirectly with circuit B (e.g., through one or more intermediaries).

While various circuits with particular functionality are shown in FIG. 2, it should be understood that the fuel controller 34 may include any number of circuits for completing the functions described herein. For example, the activities and functionalities of the circuits 110, 114, 118, 122 may be combined in multiple circuits or as a single circuit. Additional circuits with additional functionality may also be included. Further, the fuel controller 34 may further control other activity beyond the scope of the present disclosure.

As mentioned above and in one configuration, the “circuits” may be implemented in machine-readable medium for execution by various types of processors, such as processor 98 of FIG. 2. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Although the diagrams herein may show a specific order and composition of method steps, the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. All such modifications are intended to be included within the scope of the present disclosure as defined in the appended claims. Such variations will depend on the machine-readable media and hardware systems chosen and on designer choice. All such variations are within the scope of the disclosure.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

Accordingly, the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

1. An apparatus, comprising:
a control circuit structured to
receive signals from an engine sensor indicating an engine characteristic,
determine a low-load condition if the engine characteristic is less than or equal to a predetermined threshold,
control a fueling system so that a lean air-to-fuel mixture is delivered to a dedicated cylinder during the low-load condition, wherein the lean air-to-fuel mixture defines an air-to-fuel equivalence ratio equal to or greater than 1.50,
determine a tip-in event has occurred subsequent to controlling the fueling system, and
control the fueling system so that a rich air-to-fuel mixture is delivered to the dedicated cylinder after the tip-in event, wherein the rich air-to-fuel mixture defines an air-to-fuel equivalence ratio equal to or less than 0.8.

2. (canceled)

3. The apparatus of claim 1, wherein the control circuit controls a plurality of cylinders at a stoichiometric air-to-fuel equivalence ratio lambda.

4. The apparatus of claim 1, wherein the low-load condition is idle and the engine characteristic is engine speed.

5. The apparatus of claim 1, wherein the engine characteristic is torque reserve.

6. The apparatus of claim 1, wherein the tip-in event includes at least one of a user pressing an accelerator pedal, moving a throttle, or an increase in required torque.

7. (canceled)

8. A system, comprising:
an engine including a cylinder and a dedicated cylinder;
an air intake system providing fresh air to the engine;
a fueling system providing fuel to the cylinder and the dedicated cylinder;
an exhaust gas recirculation pathway from the dedicated cylinder to the air intake system; and
a controller structured to control the fueling system and the air intake system to provide a lean air-to-fuel mixture to the dedicated cylinder during a low-load condition, and to provide a rich air-to-fuel mixture to the dedicated cylinder after a tip-in event
wherein the lean air-to-fuel mixture defines an air-to-fuel equivalence ratio equal to or greater than 1.50, and
wherein the rich air-to-fuel mixture defines an air-to-fuel equivalence ratio equal to or less than 0.8.

9-10. (canceled)

11. The system of claim 8, wherein the low-load condition is idle.

12. The system of claim 8, wherein the tip-in event includes at least one of a user pressing an accelerator pedal, moving a throttle, or an increase in required torque.

13. The system of claim 8, wherein the dedicated cylinder defines a volume and the exhaust gas recirculation pathway defines a volume, and
wherein the lean air-to-fuel mixture is provided to the dedicated cylinder after tip-in for a number of engine cycles defined as a function of the volume of the exhaust gas recirculation pathway over the volume of the dedicated cylinder.

14. The system of claim 8, wherein an effective exhaust gas recirculation fraction is controlled by the air-to-fuel mixture provided to the dedicated cylinder.

15. A method, comprising:
receiving signals from an engine sensor indicating an engine characteristic;
determining a low-load condition if the engine characteristic is less than or equal to a predetermined threshold;
controlling a fueling system so that a lean air-to-fuel mixture is delivered to a dedicated cylinder during the low-load condition;
determining a tip-in event has occurred subsequent to controlling the fueling system; and
controlling the fueling system so that a rich air-to-fuel mixture is delivered to the dedicated cylinder after the tip-in event,
wherein the lean air-to-fuel mixture defines an air-to-fuel equivalence ratio equal to or greater than 1.50, and
wherein the rich air-to-fuel mixture defines an air-to-fuel equivalence ratio equal to or less than 0.8.

16-17. (canceled)

18. The method of claim 15, wherein the low-load condition is idle and the engine characteristic is engine speed.

19. The method of claim 15, wherein the tip-in event includes at least one of a user pressing an accelerator pedal, moving a throttle, or an increase in required torque.

20. The method of claim 15, wherein the engine characteristic is torque reserve.
